(19) United States
(12) Patent Application Publication
(10) Pub. No.: US 2009/0266342 A1
(43) Pub. Date: Oct. 29, 2009

(54) Fuel supply system for the composition of on demand vaporized fuel-air mixture for an internal combustion engine

(76) Inventor: Nicholas S. Morales, Hialeah, FL (US)

Correspondence Address: NICHOLAS S. MORALES, 3126 W 70 ST., HIALEAH, FL, 33018, US

(21) Appl. No.: 12/221,595

(22) Filed: Aug. 5, 2008

Related U.S. Application Data
(60) Provisional application No. 60/954,019, filed on Aug. 5, 2007.

(51) Int. Cl. F02G 5/00; F02M 29/02

(52) U.S. Cl. 123/543; 123/592

(57) ABSTRACT

This invention relates to the creation of an environmentally friendlier, higher efficiency fuel supply system for the composition of on demand vaporized fuel-air mixture for an internal combustion engine.

### RELATED APPLICATIONS

This patent application claims priority to Provisional Application Ser. No. 60/954,019 filed on Aug. 5, 2007

### BACKGROUND OF THE INVENTION

This invention aims at improving the fuel economy of the current internal combustion engine.

### BRIEF SUMMARY OF THE INVENTION

The operating principle of this fuel system is based on the idea of creating a large enclosed vertically channeled surface area or plurality thereof. Then disseminating fuel throughout said area walls and disposing said fuel to flow downwardly. Then the ambient air is disposed to flow upwardly unobstructed through the vertical channel chamber or plurality of channels chambers while the fuel is flowing downwardly creating collision and friction between the air and the fuel and accelerating the evaporation of the fuel disseminated throughout the channels chambers walls area.

### BRIEF DESCRIPTION OF THE SEVERAL VIEWS OF THE DRAWING

FIG. 1 depicts a top view and a cross sectional side view of a plurality of cylindrical channels.

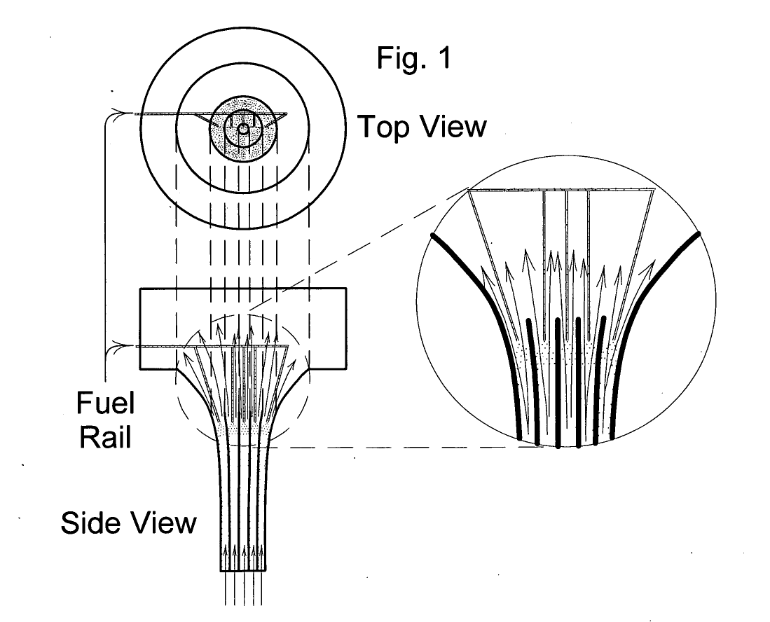

FIG. 2 depicts a cross sectional side view of a channel disposed to swivel.

FIG. 3 depicts a front view and a cross sectional side view of basic system.

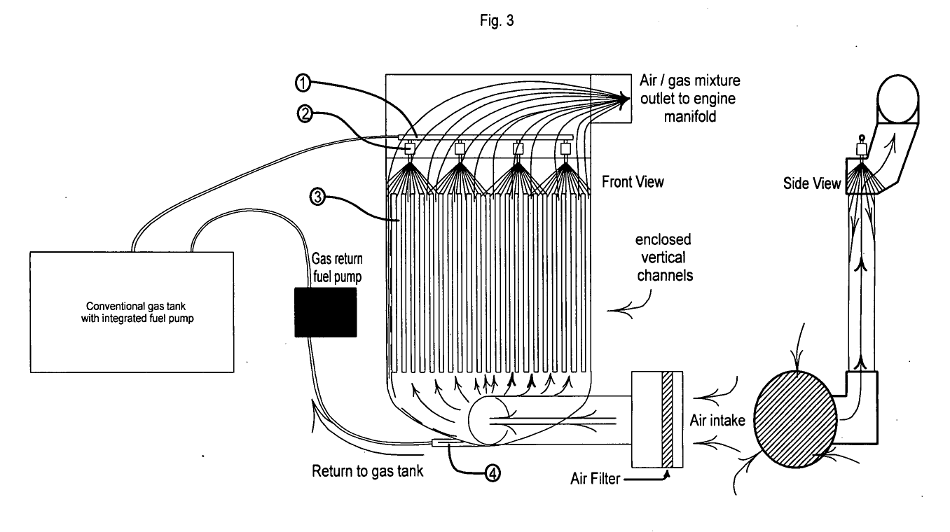

FIG. 4 depicts a top view and a side view of a diversity of channels designs.

FIG. 5 depicts a front view and a sectional side view of an intake manifold with multiple hexagonal adjacent channels.

FIG. 6 depicts a top view and a cross sectional side view of a diversity of channels designs.

FIG. 7 is a representation of a multiplicity of channels with partial fan blades.

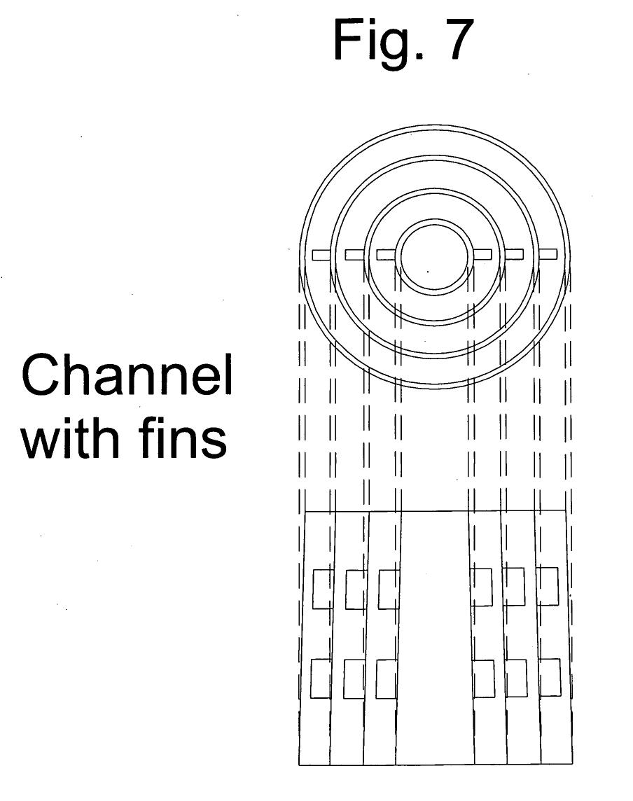

### DETAILED DESCRIPTION OF THE INVENTION

The main operating principle of this fuel system is based on the idea of creating a large enclosed vertically channeled surface area or plurality thereof. Then disseminating fuel throughout said area walls as thin as possible and disposing said fuel to flow downwardly by means of the gravitational pull and or centrifugal force. Then the ambient air is disposed to flow unobstructed upwardly through the vertical channel chamber or plurality of channels chambers while the fuel is flowing downwardly in the opposite direction creating friction between the air and the fuel and accelerating the evaporation of the fuel disseminated throughout the channels chambers walls area and at the same time, if the temperature of the incoming ambient air is higher than the fuels said friction will lower the incoming air temperature before it enters the combustion chamber. If the ambient temperature is lower than the evaporation point of the fuel then the channel may be heated. Said heat may be supplied by means of a heating element bonded to the outer surface of the channel(s), or by directing the heat generated by the engine or circulating the engine coolant through the system.

The channels chambers walls can be lined with a porous/spongy like material to allow some of the fuel to flow through the material with less resistance from the incoming air and at the same time control the fuel within the channel to reduce the effect of the changes generated by the gravitational and tangential forces exerted on the system. Furthermore the channel chamber walls can have protrusions or grooves to further channel and control the fuel, reducing the effect of the changes generated by the gravitational, and tangential forces exerted on the system when it is in motion.

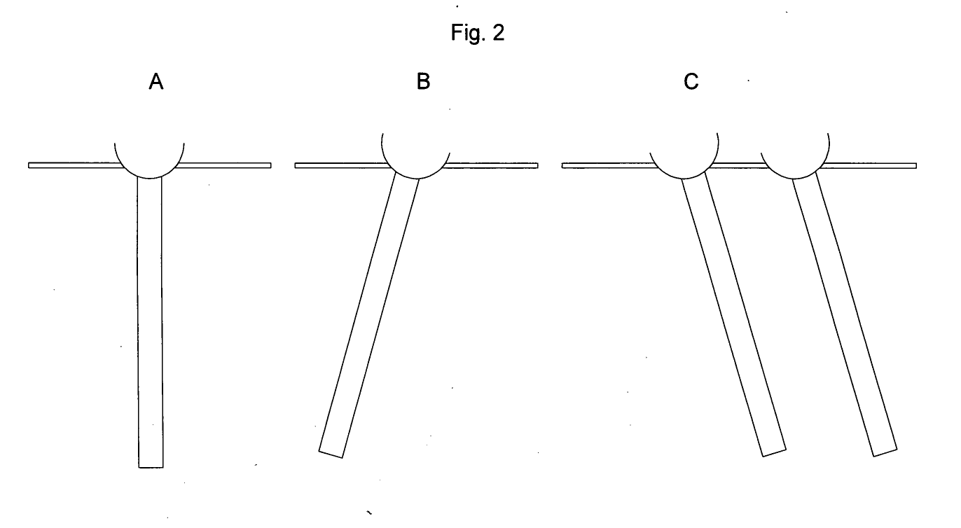

The channel can have different areas or diameters even variable areas or diameters to control the speed or volume of air flowing through the channel and ensure that the liquid fuel remains in the channels walls. The channels can also be made in a manner were they will swivel proportionally in relation to the gravitational and tangential forces exerted upon the channel(s) maintaining the resulting gravitational and tangential forces parallel with the downward flow of the fuel (FIG. 2: A, B, C).

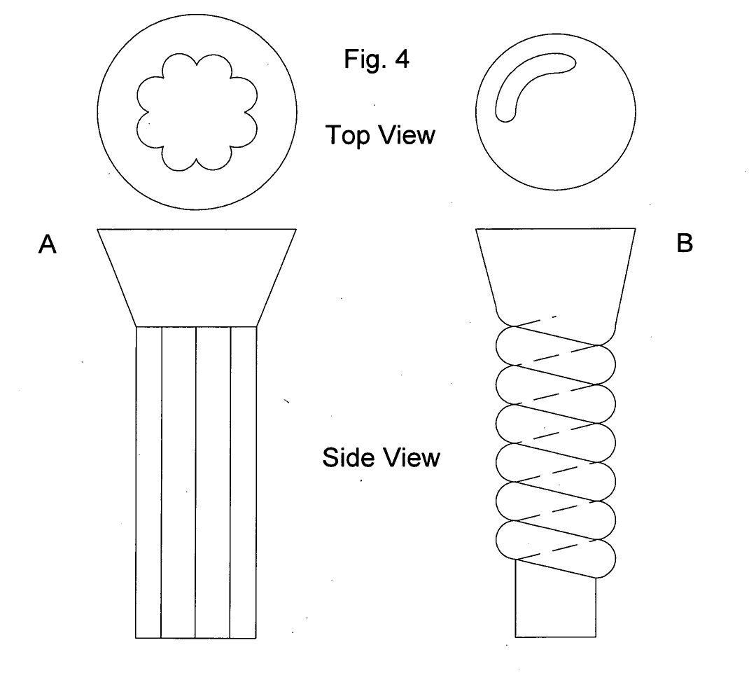

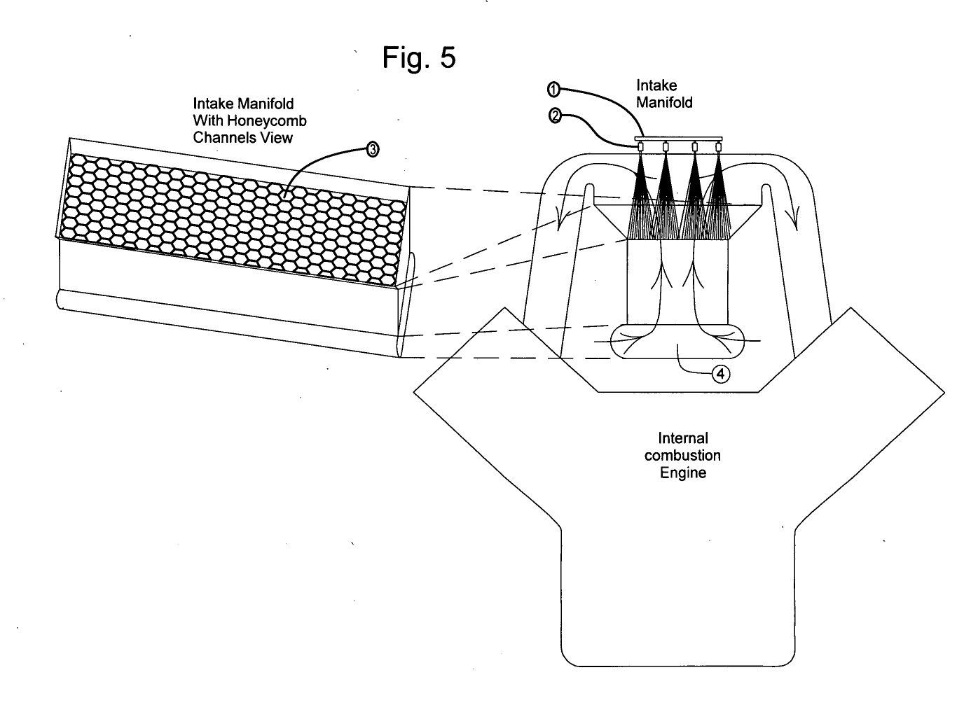

The channels may be built with slightly conical like ends (FIG. 4) to vary the incoming or out going air flow. The channels can be made with aerodynamic features like smooth curves. On a plurality of channels a means to individually or collectively control, regulate, open or close the flow through the channel or channels similar to a flap or a throttle body or the like may be used to vary the overall air flow capacity of the system. The channels can be shape cylindrically, or square, or swirl/spiral (FIG. 4), or hexagonally (FIG. 5) in a manner in which the area for interaction between the air and the fuel is maximize.

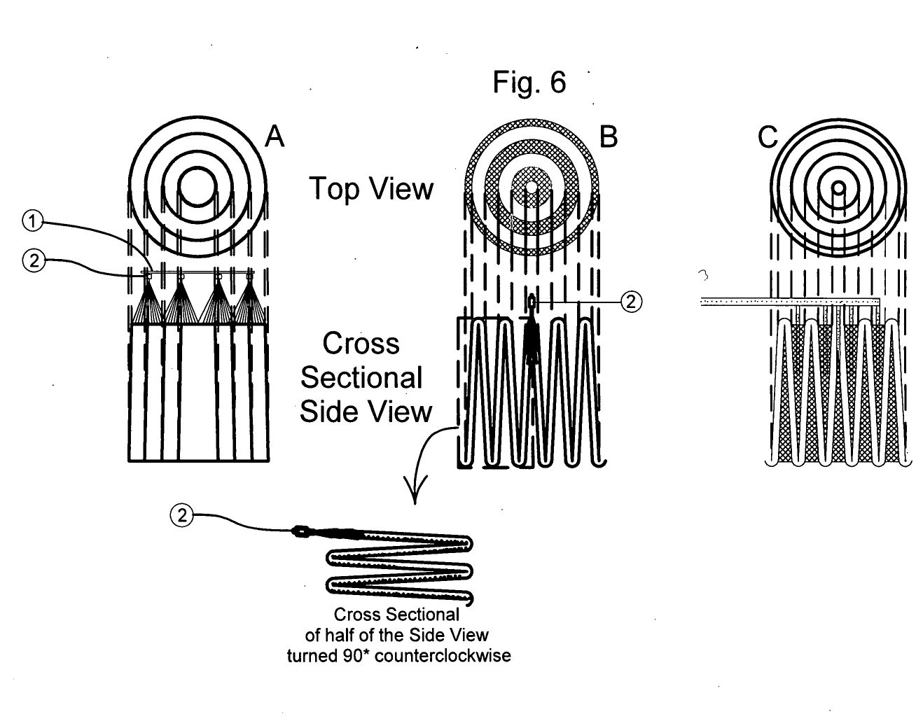

A multiplicity of channels can be comprised within a channel (FIG. 6A). Said multiplicity of channels can be made with different diameters on each end with the smallest diameter on top appearing in the likeness of a multiplicity of partial cones within each other (FIG. 6A). Said multiplicity of slightly conical likeness channels within each other can be made to spin in order to exert a centrifugal force onto the fuel delivered on to its walls to press it against said channel walls and increase its dissemination throughout the channel walls wile the slightly conical shape will ensure that the fuel is conducted downwardly toward the slightly larger diameter. Said multiplicity of slightly partially conical likeness channels within each other spinning can comprise a plurality of fan blades and or fins. Said blades and or fins can be set at a plurality of angles proportional to the diameter of the channel creating a swirl to aid the upward air flow and fuel mixing without restricting the downward flow of the fuel. Said blades and or fins can be set to capture energy from the air flowing through and self propel spin the channels without restricting the downward flow of the fuel.

The channel can be compose of a multiplicity of channels comprised within (FIG. 6A). Said multiplicity of channel can be attach to an electromechanical means such as an electric motor or it can be arrange with a means such as pulley to be accommodate into a belt driven system to make them spin. Said spinning channel can be made with slightly smaller diameter at the top this will ensure that all the fuel that makes contact with its wall is forced toward the lager diameter at the bottom of the channel in the opposite direction that the air is flowing by means of the centrifugal force generated (FIG. 6A).

On FIG. 6B and 6C once the fuel reaches the bottom of the inner channel it will precipitates onto the next adjacent outer channel. Said next adjacent outer channel has its smallest diameter on its bottom therefore when the fuel precipitates onto it will be pro-pulse along the channel walls against the in coming air toward the channels larger diameter at the top of it were the fuel will precipitate onto the next adjacent outer channel smallest diameter side and the cycle repeats it self.

The fuel can be delivered by a multiplicity of means:

The fuel can be spray from above the channels by a fuel injector, or nozzle, or a plurality thereof, the spray pattern and or the position and or angle of the injector or nozzle can vary to compensate for motion. Also the fuel can be deliver by means of a fuel line, or a fuel manifold/rail or the like to the top of the channel or channels and spry by means of a fix nozzle or an adjustable nozzle into the top of the channel or channels were the fuel will continue to disperse throughout the walls of the channel as it is pull downwardly and/or away by the gravitational and/or centrifugal force(s).

The channels walls can be made of a permeable/porous material and the fuel can flow through said material into the channels. The channel walls can be made of a permeable/porous material so that the fuel can be delivered throughout the channels walls or a portion of the channels walls and flow downwardly and/or away spreading through the channel walls into the incoming air. The excess fuel can be collected under the channels as it drips onto an appropriate collection means were it is pump and returned to the tank or back to the fuel line.

Under normal operation the fuel supplied to the system should remain in the channels walls. Under heavy loads some droplets may become air born and travel in the direction of the air. To prevent this air born droplets from entering the combustion chamber the air can be filter to remove the excess fuel and/or the area above the channels can be made large enough to slowdown the air flow and allow the air born droplets to settle and return to the channels or the reservoir. Said system may comprise supplemental fuel injector(s) to compensate for cold engine operation and sudden extreme demands. This fuel system may also encompass an Electronic Control Module (not illustrated) means to monitor the engine exhaust content/temperature and other parameters like, but not limited to, temperatures, revolutions per minutes, throttle position, ignition timing, ambient temperature, fuel temperature, engine temperature, air flow, intake mixture composition/temperature, crank position etcetera and provide feed back to said control means which in response to said feedback will adjust the fuel supply (reduce or increase the fuel delivery) means as necessary. Said control means may keep the engine on for a predetermine period of time after the ignition switch has been turned off to purge the system. Safety measurements that are well know within the industry such as but not limited to a cutoff switch to the fuel pump incase of an accident, impact, overturn etc. may be incorporated.

When the fuel vaporization system is incorporated as an add-on or a supplemental fuel system to an existing electronic fuel injection system or other fuel system the fuel vaporization system may comprise a means to interface, monitor and control the existing fuel system to disable or reduced the existing fuel system delivery capabilities i.e. a switch to disable the fuel injectors depending on the revolution per minute, throttle position or any combination of parameters well know in the art deem necessary to achieve optimal system performance.

A fuel vaporization system will ensure a more complete and efficient combustion and therefore more heat. Said heat may create a premature detonation of the in coming fuel-air mixture known as knocking. In order to avoid said knocking a water injection system as those well known in the art may be installed. Said water injection system may be control by the fuel vaporization system.

What is claimed is:

1. A fuel vaporization system for internal combustion engines comprising a large enclosed vertically channeled surface area or plurality thereof with a fuel supply disposed from above to disseminate fuel throughout said enclosed walls areas and disposing said fuel to flow downwardly by means of the gravitational pull and or centrifugal force while the ambient air is disposed to flow in the opposite direction unobstructed, upwardly through the vertical channel chamber or plurality of channels chambers creating friction between the air and the fuel wile mixing them and accelerating the evaporation of the fuel disseminated throughout the channels chambers walls area.

2. A fuel vaporization system as on claim 1 were the channel or a plurality of channels may be heated by means of a heating element attachment to the outer surface of the channel or a plurality of channels.

3. A fuel vaporization system as on claim 1 were the channel or a plurality of channels may be heated by redirecting some of the heat generated by the engine through the system.

4. A fuel vaporization system as on claim 1 were said system comprises a supplemental fuel injector or a plurality thereof to compensate for cold engine operation and sudden extreme demands.

5. A fuel vaporization system as on claim 1 were the channels chambers walls can have protrusions and/or grooves and/or can be lined with a permeable/spongy like material.

6. A fuel vaporization system as on claim 1 were the channels can also be made in a manner were they will swivel.

7. A fuel vaporization system as on claim 1 were the channel can have different areas dimensions and/or diameters and/or variable areas and/or diameters.

8. A fuel vaporization system as on claim 1 with a means similar to a flap or a throttle body or the like that can individually or collectively control, regulate, open or close the flow through the channel or channels.

9. A fuel vaporization system as on claim 1 were a channel or a plurality of channels comprise within are dispose to spin on a common axis.

10. A fuel vaporization system as on claim 1 were the channel or a plurality thereof can comprise a plurality of fan blades.

11. A fuel vaporization system as on claim 8 were the channel is dispose to be attached to an electromechanical means such as an electric motor or belt system.

12. A fuel vaporization system as on claim 1 comprising a fuel injector or a plurality of injectors dispose to dynamically supply the channel or a plurality of channels.

13. A fuel vaporization system as on claim 1 comprising a nozzle or a plurality of nozzles dispose to dynamically supply the channel or a plurality of channels.

14. A fuel vaporization system as on claim 1 were the channel or a plurality of channels walls are of a permeable configuration.

15. A fuel vaporization system as on claim 1 that comprises an electronic control means.

16. A fuel vaporization system as on claim 1 that comprises a conventional fuel tank with integral fuel pump dispose to supply the system.
